(19) United States
(12) Patent Application Publication
(10) Pub. No.: US 2022/0411666 A1
(43) Pub. Date: Dec. 29, 2022

(54) FILM AND PACKAGING MEMBER FOR THE FORMATION OF PACKAGES

(71) Applicant: PROFOL GMBH, Halfing (DE)

(72) Inventor: Christian HÜBNER, Maisach (DE)

(21) Appl. No.: 17/780,756

(22) PCT Filed: Nov. 27, 2020
(86) PCT No.: PCT/EP2020/083650

§ 371 Date: May 27, 2022

(30) Foreign Application Priority Data
Nov. 27, 2019 (DE) 10 2019 218 364.6

(51) Int. Cl. C09J 7/29; B32B 27/08; B32B 27/32; B32B 7/12; B32B 7/06; B65D 65/40; C09J 7/38

(52) U.S. Cl. CPC C09J 7/29; B32B 27/08; B32B 27/32; B32B 7/12; B32B 7/06; B65D 65/40; C09J 7/385; B32B 2307/732; B32B 2405/00; B32B 2439/70; B32B 2307/748; C09J 2423/006; C09J 2423/046; C09J 2423/106

(57) ABSTRACT

A film or packaging member for forming a package comprising at least one body and at least one outer adhesive layer, wherein the body and adhesive layer are made of a polyolefin-based plastic, wherein at least the adhesive layer is fusible to be weld to a target surface, and wherein at least the adhesive layer comprises particles that absorb radiation to heat at least a portion of the packaging member.

### TECHNICAL FIELD

The present invention relates to a film for forming a package. In this regard, the film may be applied to a target article or may itself be formed into a package by welding at least a region of the film to a region of the target article or to a further region of the film. The film can be welded with a tool under the action of heat and/or pressure and, in a preferred embodiment, forms, for example, a lid of a paper or jar package or a packaging bag. Such packaging finds particular use in the packaging of foodstuffs, bulk or liquid goods and other consumer products. The present invention also relates to a corresponding packaging component.

### TECHNOLOGICAL BACKGROUND

Plastic films provide an essential part in the packaging of foodstuffs, medicines, cleaning and care products, or consumer goods in general. In recent years, the aspect of reusability and/or orderly disposal has increasingly come to the fore, particularly in the case of plastic packaging. In this context, parts of a product packaging or the entire packaging are considered in terms of how much effort is required to reuse the packaging. For example, a plastic bottle can be cleaned and refilled, the plastics of a package can be separated, shredded and returned to the manufacturing process for new packaging, or a plastic can be put to another use. These aspects and processes are collectively referred to as reuse/recovery or recycling.

A difficulty often arises from a lack of or too low grade purity, i.e. a packaging consists of several components made of different materials or plastics. For example, it is difficult to recycle an empty plastic yogurt pot with the remains of an aluminum foil attached. The use of different plastics also poses problems, whereby this applies not only to materials from different polymer (classes) but also to identical polymers or polymer classes that contain additives in different or excessive quantities.

Overall, this leads to a more holistic view of a package and to the desire to manufacture all components of a package, such as a yogurt cup and an associated lid, from one or at least compatible plastics. The word “compatible” in this context is to be understood as meaning that, although the respective plastics may differ in composition, the differences in composition do not present any significant obstacles to reuse. A first step, therefore, is to select, manufacture and, if necessary, refine plastics in such a way that they can then be further processed into recyclable packaging or the various components of recyclable packaging.

A second step is then to be seen in the packaging infrastructure, i.e. in the existing processes and equipment for filling and/or packaging the goods. Here, it should be noted in particular that the existing infrastructure cannot necessarily process the new plastics and packaging materials, but at the same time cannot be replaced without enormous effort. Therefore, it is further necessary to provide packaging materials that can be processed with the existing infrastructure, i.e. existing packaging and filling equipment, and existing processes, i.e. existing conditions regarding temperature, purity, speed, etc.

The task is therefore to provide a plastic film that can be used to achieve packaging that is as pure as possible and, if necessary, also multi-component. The aim is not only to meet the requirements of the packaging in terms of reusability or recyclability, but also to satisfy all the requirements placed on the packaging of the product itself, such as stability, food compatibility, optical appearance and properties, etc. The film should also be suitable for use in existing equipment. Furthermore, the film should also be able to be processed in existing plants with no or only minor modifications.

### SUMMARY

The problems and tasks mentioned are solved by the objects of the independent patent claims. Further advantageous embodiments of the present invention are indicated in the dependent patent claims.

According to one embodiment of the present invention, there is provided a film for forming a package comprising at least one cover layer and at least one adhesive layer, wherein the cover layer is made of a first polyolefin-based plastic having a first layer thickness, wherein the adhesive layer is made of a second polyolefin-based plastic having a second layer thickness, wherein at least the adhesive layer is fusible to be welded to a target surface, and wherein at least the adhesive layer has particles that absorb radiation to heat the at least a portion of the film.

According to another embodiment of the present invention, there is provided a packaging member for forming a package comprising at least one body and at least one outer adhesive layer, wherein the body and the adhesive layer are made of a polyolefin-based plastic, wherein at least the adhesive layer is fusible to be welded to a target surface, and wherein at least the adhesive layer has particles that absorb radiation to heat at least a portion of the packaging member.

### BRIEF DESCRIPTION OF FIGURES

The embodiments of the present invention will be explained and clarified particularly in the context of the following figures. In this regard, the scope of protection is not intended to be limited to this embodiment and, accordingly, the figures and accompanying description serve only to illustrate the general ideas of the invention. In the attached figures

FIGS. 1A to 1E show schematic sectional views of films according to corresponding embodiments of the present invention;

FIGS. 2A to 2F show schematic views of packages or parts of packages formed with the film according to corresponding embodiments of the present invention;

FIG. 3 shows a schematic view of a device for forming a package with a film according to an embodiment of the present invention, and

FIGS. 4A to 4C show schematic views of tools as a possible part of an apparatus for forming a package with a film according to one embodiment of the present invention.

### DETAILED DESCRIPTION

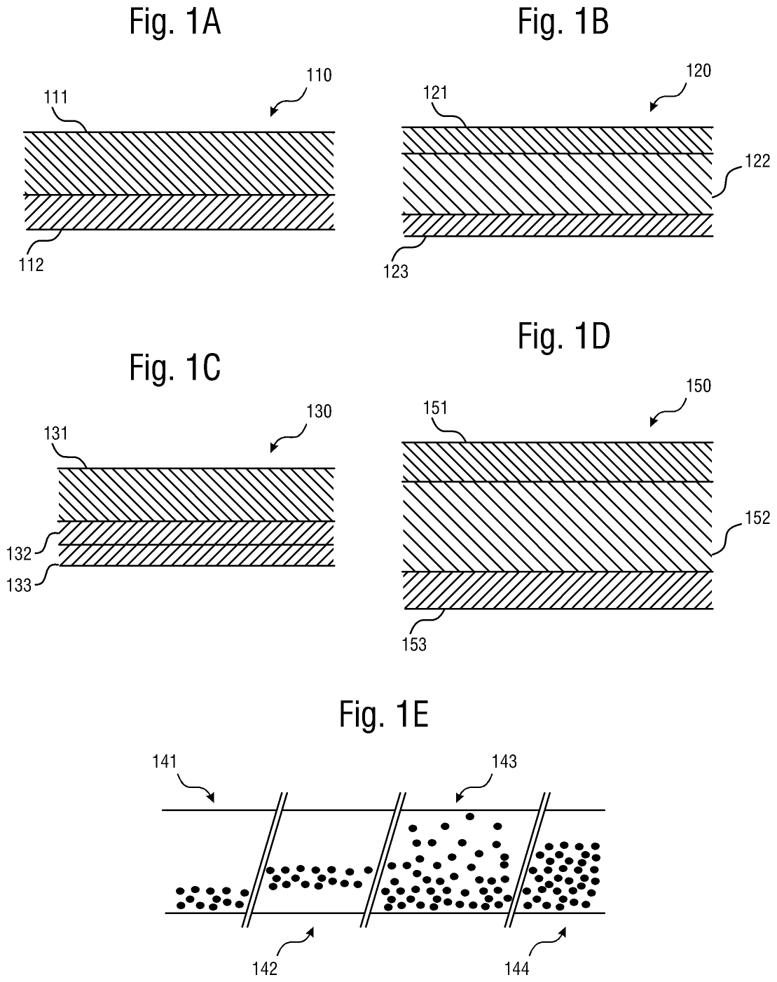

FIGS. 1A to 1D show schematic sectional views of films according to corresponding embodiments of the present invention. In FIG. 1A, a film 110 is provided for forming a package comprising at least one cover layer 111 and at least one adhesive layer 112. The cover layer 111 has or is made of a first polyolefin-based plastic and has a first layer thickness. The adhesive layer 112 comprises or is made of a second polyolefin-based plastic and has a second layer thickness. At least the adhesive layer 112 is fusible to be welded to a target surface, and at least the adhesive layer 112 comprises particles that absorb radiation to heat at least a portion of the film.

In a preferred embodiment, the particles are excitable by high-energy radiation, in particular, to heat up and release that heat to the environment in the film. Preferably, these particles may be present at a concentration in a range from 50 ppm to 500 ppm, further preferably in a range from 100 ppm to 150 ppm, and may comprise one or more of the following compositions: Copper, copper compounds, iron, pure iron or corresponding compounds. In the context of the present disclosure, “ppm” refers to the corresponding weight fraction.

Preferably, the absorption characteristics of the particles are adapted to a radiation to be used, in particular to a wavelength or range of wavelengths of radiation in the form of infrared light, visible light, ultraviolet light, or electromagnetic radiation in general and/or particle radiation. Preferably, the radiation used penetrates the first and/or second polyolefin-based plastic, so that a region of the film can be selectively heated. In particular, the heating can be used to prepare the film for welding. In this way, the film can be exposed to radiation over a wide area or selectively before forming the package and can thus be selectively heated. If the film prepared in this way is then welded to a target surface using a tool, the tool only has to apply a reduced amount of heat to melt at least the adhesive layer for welding. In particular, this can spare stress on other parts of the film, especially the cover layer 111 during welding, and thus, for example, reduce or substantially completely prevent damage, warpage, cracking, or the like.

In FIG. 1B, a film 120 is provided for forming a package comprising at least one cover layer 121, a core layer 122, and at least one adhesive layer 123. The cover layer 121 and/or the core layer 122 are made of or at least have a first polyolefin-based plastic, the upper cover layer 121 forms a first layer thickness together with the core layer 112, and the adhesive layer 123 is made of a second polyolefin-based plastic having a second layer thickness. In general, what has been said for the embodiments in connection with FIG. 1A applies to the arrangement according to 1B. In particular, at least the adhesive layer 123 comprises the aforementioned particles.

In FIG. 1C, a film 130 for forming a package is shown, which again has at least a cover layer, here 131, and an adhesive layer, here 133, as already described. With regard to all further properties such as layer thickness, materials and fillers, the preferred embodiments according to the descriptions in connection with FIGS. 1A and 1B apply in each case. Furthermore, in this embodiment a further layer 132 is provided, so that overall a three-layer structure results from a cover layer, a “first” adhesive layer 132 as a separable or peelable release/peel layer, and the “second” adhesive layer 133 originally already provided as a non-separable or peelable sealing layer. For example, the film 130 can be welded onto a target object in the form of a container (e.g. yogurt pot) and seal it tightly. When the package is opened and, if necessary, for its resealing, the further layer 132 can then serve to enable uniform and clean opening or resealing.

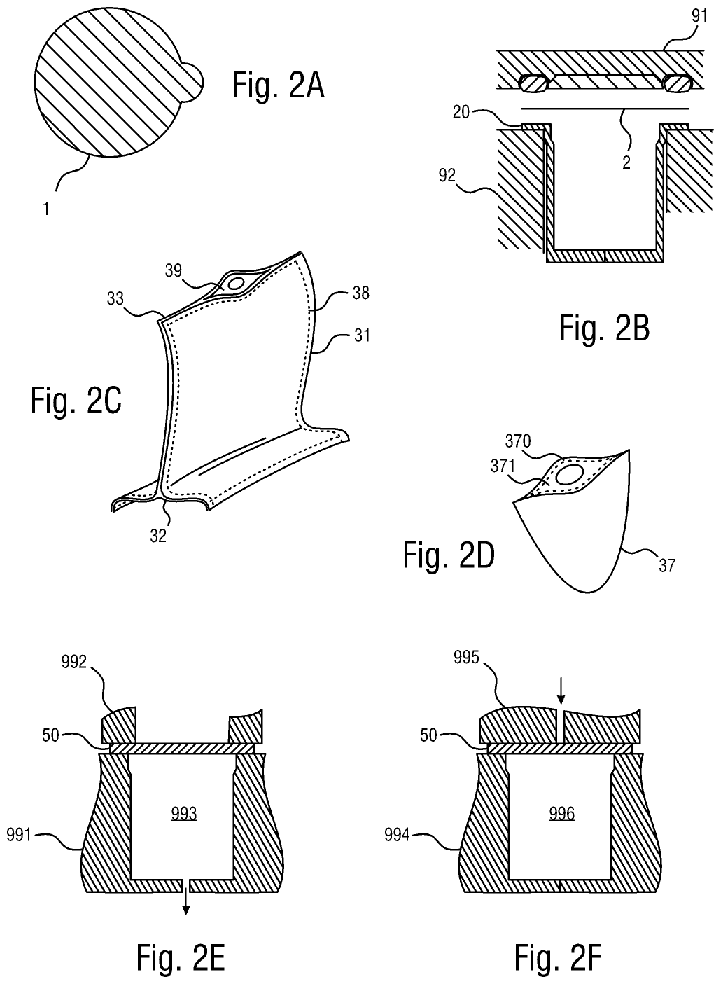

In FIG. 1D, a film 150 for forming a package is shown, which has at least a cover layer 151, a core layer 152 and an adhesive layer 153. With regard to the further properties such as materials and fillers, the preferred embodiments according to the descriptions in connection with the other figures apply in each case. As can be seen—but only schematically—in comparison with the preceding figures and descriptions, in this embodiment the layer thickness of the film 150 is increased overall. Thus, the layer thickness of layer 151 can preferably be in a range of 5 to 20 μm, the layer thickness of layer 152 can preferably be in a range of 140 to 260 μm, the layer thickness of layer 153 can preferably be in a range of 5 to 20 μm, and thus the overall layer thickness of film 150 can preferably be in a range of 150 to 300 μm. In this embodiment, the increased layer thickness has the function of enabling the production of a package by a deep-drawing process, as described, for example, in connection with FIGS. 2E and 2F.

In a further embodiment, a film for forming a package by thermoforming is provided in a single-layer configuration, e.g. only the layer 152 of the aforementioned embodiment, with a total layer thickness in a range of 140 to 300 μm.

FIG. 1E shows possible concentration profiles of the particles within a film according to the invention according to corresponding, respective embodiments. The profiles and arrangement shown schematically there are in principle independent of the exact sub-layer structure, for which examples have already been discussed in connection with FIGS. 1A to 1D above. The description therefore relates to the main focus of a concentration of particles absorbing radiation to heat at least part of the film, and corresponding concentration profiles along a cross-sectional direction of the film, but with the cover layer or layers arranged at the top, and adhesive layer(s) at the bottom.

At 141, a first concentration profile is schematically shown in which the particles are provided substantially in a region of the adhesive layer. This can be advantageous if the radiation arrives from a side facing the adhesive layer, in this case from below. Thus, the adhesive layer can be selectively heated to prepare it for welding.

At 142, a second concentration profile is schematically shown, in which the particles are provided substantially in a region above the adhesive layer or in an upper region thereof. This can be advantageous if, for other reasons, the adhesive layer is to have as low a proportion of the particles as possible, but is still to be effectively heated to prepare it for welding.

At 143, a third concentration profile is schematically shown in which the particle concentration increases coming from above to assume at least a relative maximum in a region of the adhesive layer itself. This can be advantageous if distortion or internal stress in the film is to be avoided. Thus, in particular, an abrupt temperature change in the film can be avoided.

At 144, a fourth concentration profile is schematically shown, in which the particles are provided substantially only in the core layer and a lower layer. With exemplary reference to the preceding FIG. 1D, only layers 152 and 153 may thus have the particles.

In further corresponding embodiments, the second layer thickness is less than the first layer thickness, and/or the adhesive layer 112 may comprise an inorganic filler having a weight fraction greater than 20%. In general, the cover layer(s) may have a layer thickness in a range of 70 μm to 105 μm and the adhesive layer may have a layer thickness in a range of 7 μm to 20 μm (preferably about 8 μm). If a multilayer cover layer is provided, such as shown in FIG. 1B, the upper cover layer may have a layer thickness in a range of 10 μm to 20 μm, and the core layer may have a layer thickness in a range of 60 μm to 85 μm.

In general, the polyolefin-based plastics may each comprise polyethylene (PE) and/or polypropylene (PP), and the adhesive layer may comprise one or more acrylates. The inorganic filler may comprise particles of chalk, lime, talc, and/or platelet-shaped particles, where the diameter of the particles may range from 0.7 μm to 3 μm. The weight fraction of the inorganic filler may be in a range from 20% to 30%, and further preferably in a range from 25% to 50%.

FIGS. 2A to 2F show schematic views in connection with the use and advantages of films according to corresponding embodiments of the present invention. In FIG. 2A, a shaped piece 1 of a film according to one embodiment of the present invention is shown from above. The shaped piece may thereby serve a sealing lid of a vessel, for example as part of a food package, and therefore have a tab which facilitates a removal of the lid.

As shown in FIG. 2B, a piece 2 of a film according to one embodiment of the invention, for example also the shaped piece of FIG. 2A, can form a lid for a vessel 20 (e.g. cup) as part of the package to be formed. The piece 2 of the film is applied, for example, to an edge of the vessel 20. This application may comprise welding with a tool 91. The properties of the film according to embodiments of the present invention allow the lid to be applied to the target article in a manner such that no contamination occurs in and around a closure area. The piece 2 of the film may be exposed to radiation prior to sealing, such that at least a portion of the film advantageously heats up. The radiation can thereby originate from a radiation source or also emanate in the form of thermal radiation from a heated tool 91.

Furthermore, the film can be peeled off (“peelable”) from the target object in a simple manner without tools and uniformly. These advantages can be achieved in particular by the preferred selection of the filler(s) in the adhesive layer and its/their concentration. In particular, residue-free peeling achieves a satisfactory opening experience, i.e. the user experiences the sensation of reliable closure and appropriate opening. Moreover, in a further advantageous manner, this also makes it possible to see that the closure point does not contain or contained any contamination (by, for example, the goods or foodstuffs to be packaged) and leaks. Also, satisfactory and reliable resealing can be made possible, for example, by providing additional layers.

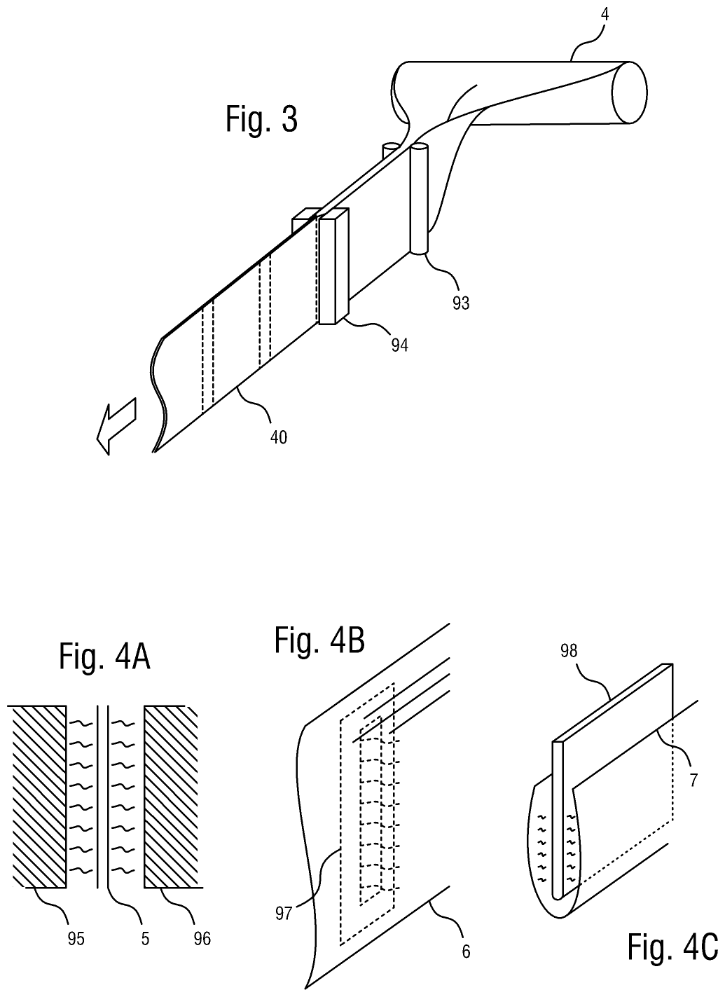

As shown in FIG. 2C, several pieces or parts 31, 32, 33 of a film according to the invention can also be welded along a seam 38 to form a bag, a pouch, or—as shown—a stand-up pouch, in order to form a package. Preferably, the two adhesive layers of two film pieces or areas are welded together. Also, another packaging member 39 can be welded as well, for example to provide easy product removal, pouring out or pouring in and/or closure of the package. Further details on the formation of similar bag-shaped packages and—also in general—other-shaped packages are also described in connection with FIG. 3 as well as 4A to 4C.

As shown in FIG. 2D, other components or packaging members 37, such as a shrink-wrap piece 37, may also be provided with an outer layer 370 to form a package, in accordance with a further embodiment of the invention. Generally, then, there is provided a packaging member 37 for forming a package, which includes a body 371 and at least one outer adhesive layer 370, wherein the body 371 and the adhesive layer 370 are made of a polyolefin-based plastic, the adhesive layer 370 is fusible to be welded to a target surface, and at least the adhesive layer 370 includes the aforementioned particles that absorb radiation to heat at least a portion of the packaging member. Overall, then, the packaging member 370 may be made of a suitable plastic as mentioned and have the particles at least in part in an outer peripheral region. Thus, an outer layer 37 is formed in the sense of an adhesive layer having the particles absorbing radiation to heat at least a portion of the packaging member.

Thus, in an advantageous manner, the packaging member 370 can also be heated before being welded to pieces of a film, for example to form a stand-up pouch as shown in FIG. 2C. Irradiation of the packaging member 370 results in at least the outer region, i.e. in particular the region which is subsequently to be sealed, being heated. This then provides the advantage that less heat has to be transported through the film during the welding process in order to weld the packaging member to the film. This process can thus be carried out more quickly, and the reduced thermal stress on the outer packaging film also leads to less warpage and thus also to visually flawless packaging. In general, it should also be said with respect to a packaging member according to the invention that what has been described in detail with respect to the embodiments of the film in terms of plastics, materials, layer thicknesses, particles and particle concentrations can also apply correspondingly to the packaging member.

As shown in FIGS. 2E and 2F, to form a package and/or to form a further component or packaging member, a thermoforming process can be used. In a thermoforming process for plastics, a plastic blank is sucked (FIG. 2E) or pressed (FIG. 2F) into a mold cavity. In this embodiment, a plastic blank 50 is made from a film according to the invention with increased layer thickness, such as the film 150 described in connection with FIG. 1D. First, this blank 50 is heated up in order to perform a subsequent reshaping. Due to the particles, which absorb radiation, this process is faster and gentler for the plastic, since the entire amount of heat does not have to be conducted through a part of the layer (in the sense of heat conduction), but the energy in the form of radiation can pass through this part of the film and is only converted into heat locally at the desired location by the particles.

As shown in FIG. 2E, the warm blank 50 is held by a holder 992 on a mold 991 with a mold nest 993 and is sucked into the latter by negative pressure. Here, for example, a mold nest 993 is shown for forming a cup (e.g., the cup 20 described in connection with FIG. 2B). In an analogous manner, FIG. 2E shows how a warm blank 50 is held by a holder 995 on a mold 994 having a mold nest 996 and is pressed into the latter by overpressure.

FIG. 3 shows a plant and, in general, an embodiment in which, in particular, bag- or pouch-shaped packages are produced from a film 4 according to the invention. For this purpose, the film 4 can first be folded once or several times by means of corresponding guide members 93. In a folded state, in which advantageously corresponding sections of the adhesive layer face each other. In this state, the film can then be welded by means of one or more tools 94. In total, a plurality of packages 40 are thus obtained from the film 4, this advantageously in a quasi endless linear composite.

In this context, it may be mentioned that the method of manufacturing a plurality of packages in an endless process may subject the film and the packaging composite to severe stresses. In particular, a composite is often pulled at high speed through a production line, and the composite—in particular then also the melted weld seam, fresh weld seams and all weld seams still exposed to tension—must bear or at least partially dissipate the force necessary for conveying.

Here, the embodiments of the present invention can provide significant advantages. Since the points and areas to be welded can be preheated in the broadest sense, the formation of the weld seam can take place more quickly and with less heat input. The reduced heat input thus allows faster processing or use of existing equipment with films that have the improved properties already discussed with regard to reuse (recycling). Also, by concentrating the heat on the areas of the film that actually need to be melted, warpage or damage to the packaging compound can be avoided while maintaining or even increasing the processing speed. In the context of product packaging, this is particularly important with regard to a decoration or print on the film: the desired visual impression of the finished packaging can also be achieved at the required processing speed.

FIGS. 4A to 4C show schematic views of tools as a possible part of a device for forming a package with a film according to one embodiment of the present invention. In FIG. 4A, an irradiation of a film or film layer 5 by thermal radiation is shown. In particular, tools 95, 96, for example the heated pressing jaws of a sealing tool, can convey heat to the desired area of the film even without approach and force, in that the thermal radiation of the tools is absorbed by the particles at the right place in the film and heats up the corresponding target areas of the film.

FIG. 4B schematically shows a radiator which exposes a film to radiation through an aperture 97. The radiation source can be intermittently shaded by a further diaphragm or an electrical switching device so that well-defined areas of radiation exposure, and thus of targeted heating, are obtained even when the foil 6 is moved along the diaphragm 97.

Finally, FIG. 4C schematically shows a heating blade 98 which can be inserted into a folded film so as to deliver heat radiation to the inside of the film. Overall, for example, one or more of the tools of FIGS. 4A to 4C can be used in a production system according to FIG. 3. For example, a radiant heater according to the embodiment in FIG. 4B or 4C can be placed in front of a conventional welding press 94 in order to minimize the necessary heat input and the process time there. Radiant heating with the jaws themselves as in FIG. 4A can also be implemented in the system in FIG. 3, for example by briefly stopping the film and composite with the jaws 94 open in order to preheat the desired areas of the film 4 before conventional processing, i.e. welding, is carried out with the tool 94.

Generally, the polyolefin-based plastics may each comprise polyethylene (PE) and/or polypropylene (PP), and the adhesive layer may comprise one or more acrylates. Preferred polymer configurations are homopolymers, e.g., propene or propylene (=P) as monomer in a configuration P-P-P-P-P-P-P- . . . , block polymers, e.g., in a heterophasic form with ethylene (=E) and propylene (=P) in a configuration P-P-E-E-P-P-P-E-E-E-E-P-P-E-E-E- . . . , random copolymers, e.g. with propene and in a relatively small amount of ethene and/or buthene in a randomly distributed configuration P-P-P-E-P-P-E-P-P-P-E-P-P-P- . . . , or random block copolymers, which are a combination of the preceding two configurations as random copolymers with ethene-propene rubber particles (EPM) dispersed configuration P-P-P-E-P-P-P-E-E-P-P-P-E-P-P-P-E-P-P-P-E-P-P-P-P-P-P-P-E-P . . . .

Said adhesive layers may further comprise an inorganic filler in the form of further particles of chalk, lime, talc, and/or platelet-shaped further particles, wherein the diameter of the further particles may be in a range from 0.7 μm to 3 μm. The weight fraction of the inorganic filler may be in a range from 20% to 30%, and further preferably in a range from 25% to 50%.

Furthermore, the plastics in general may have further additives, such as polybutene, reduction Tm, elastic components, or so-called impurities, which altogether individually or as a combination provide the desired properties of the film or individual layers.

Although detailed embodiments of the invention have now been described, these should only serve for a better understanding of the invention and its effects. The scope of protection is defined by the following claims and should not be limited by the detailed description.

1. A film for forming a package, the film comprising at least one cover layer and at least one adhesive layer, wherein:
the cover layer comprises a first polyolefin-based plastic having a first layer thickness;
the adhesive layer comprises a second polyolefin-based plastic having a second layer thickness;
at least the adhesive layer is fusible to be welded to a target surface; and
at least the adhesive layer comprises particles that absorb radiation to heat at least a portion of the film.

2. The film according to claim 1, wherein the cover layer has a layer thickness in a range of 5 μm to 20 μm.

3. The film according to claim 1, further comprising a core layer between the cover layer and the adhesive layer, wherein the core layer consists of the first polyolefin-based plastic.

4. The film according to claim 3, wherein the core layer has a layer thickness in a range of 20 μm to 260 μm.

5. The film according to claim 1, further comprising a further layer within the film and below the adhesive layer, wherein the further layer is designed as a separable separation layer.

6. The film according to claim 5, wherein the separation layer has a layer thickness in a range from 5 μm to 20 μm.

7. The film according to claim 1, wherein the film as a whole has a layer thickness in a range from 140 μm to 300 μm.

8. The film according to claim 1, wherein the particles have a concentration in a range from 50 ppm to 500 ppm by weight.

9. The film according to claim 1, wherein a particle concentration of the particles increases in a direction from the cover layer to the adhesive layer to assume at least a relative maximum in a region of the adhesive layer.

10. A packaging member for forming a package, the packaging member comprising at least one body and at least one outer adhesive layer, wherein:
the body and the adhesive layer are made of a polyolefin-based plastic;
at least the adhesive layer is fusible to be welded to a target surface; and
at least the adhesive layer comprises particles that absorb radiation to heat at least a portion of the packaging member.

11. The film according to claim 1, wherein the particles have a concentration in a range of 100 ppm to 150 ppm by weight.
